(19) United States
(12) Patent Application Publication
(10) Pub. No.: US 2007/0108181 A1
(43) Pub. Date: May 17, 2007

(54) Domestic appliance with a linearly movable component

(75) Inventors: Joerg Gassmann, Dresden (DE); Roman Goldberg, Dresden (DE); Kai Nitschmann, Neuenhagen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/593,978

(22) Filed: Nov. 6, 2006

(30) Foreign Application Priority Data
Nov. 16, 2005 (DE) 10 2005 054 681.1

(51) Int. Cl. A21B 1/00

(52) U.S. Cl. 219/400

(57) ABSTRACT

A domestic appliance containing a linearly movable component 8, 9 which can be moved by means of an, in particular metal and convex, drive band 12. The domestic appliance is, in particular, an apparatus for drying laundry 1 by means of an air stream. The apparatus comprises a drum 2 for holding the laundry 1 and a duct system 3, 4, 5 for conducting the air stream. The duct system 3, 4, 5 has a section 3 which is arranged at the outflow end of the drum 2 and in which the air stream is conducted in a downward direction and in which a filter 6 for capturing lint 7 from the air stream is arranged. The filter 6 has an associated scraper 8, 9 for scraping off lint 7 which have been captured, and this scraper 8, 9 is the component 8, 9 which can be moved by means of the drive band 12.

The invention relates to a domestic appliance with a linearly movable component.

A domestic appliance of this type is disclosed in DE 39 24 586 C2 and EP 0 465 800 B1 in each case; the disclosures of both of these documents are to be included in the current disclosure in their entirety.

DE 39 24 586 C2 relates to a domestic appliance in the form of a washing machine with a linearly movable component in the form of a detergent dispenser which can be moved by a electromagnetic drive means which can be operated by an electrical switching means. The switching means is, in particular, a key which can be operated by a user. The drive means is, in particular, an electromagnet with a movable armature or an electric motor which may be designed as a linear motor. Force may be transmitted within a correspondingly provided conventional electric motor by means of a pivoting lever or a toothed rack. EP 0 465 800 B 1 discloses a washing machine with a detergent dispenser which can be driven by an electric motor, in which force is transmitted by means of an actuating rod which can be wound at least over part of its length and in particular is toothed.

A domestic appliance which is designed as a domestic tumble dryer is disclosed in EP 1 050 619 B1, DE 44 03 183 C2 and DE 199 24 297 A1 in each case. The domestic appliance according to each of these documents contains a flat filter which serves to capture lint which is detached and carried along by a heated air stream during drying of the laundry which is agitated in a rotating drum. The lint which is captured on the filter have to be removed at regular intervals so that the flow resistance of the filter to the air stream remains sufficiently low and drying of the laundry is not adversely affected. To this end, a linearly movable scraper is provided in each case, which scraper is periodically operated in order to scrape off the captured lint from the filter. According to EP 1 050 619 B1, the filter is designed as part of an endless belt and, in a manner driven by a motor, can be moved past the stationary scraper over its entire effective length. The lint which is thus scraped off from the filter is collected in a reservoir.

According to DE 44 03 183 C2, the filter is designed as a stationary surface and a movable scraper brushes over it in order to scrape off lint which has been captured; the scraper is connected to a closing mechanism of the door of the tumble dryer by means of a corresponding transmission, so that the scraper is passed over the filter each time the door is opened. According to DE 199 24 297 A1, a domestic tumble dryer is provided with a self-cleaning lint filter, a corresponding sensor system and a correspondingly designed control device, in order to identify an impermissibly high flow resistance at the lint filter during a drying process and to remedy this by initiating self-cleaning of the lint filter. The disclosures of the three documents cited here are to be included in the current disclosure in their entirety.

Each of the domestic appliances described in one of the abovementioned documents is distinguished by a drive for a functionally relevant, linearly movable component and therefore meets the requirements of a user who is interested in a certain degree of convenience when operating the domestic appliance. However, each of the described drives is disadvantageous both in terms of the mechanics employed and also in terms of the costs involved.

Accordingly, the invention which will be described below is based on the object of providing a domestic appliance of the type mentioned in the introduction which manages with a drive which is simpler and more cost-effective than any of the known domestic appliances.

In order to achieve this object, the invention specifies a domestic appliance with a linearly movable component, wherein, according to the invention, the component can be moved by means of a drive band.

A drive band is a preferably convex strip which is produced from a highly flexible metal, in particular a suitable steel, and can transmit a shearing force in addition to a tensile force and is conventionally used as a tape measure which can be rolled up. Said drive band can be bent relatively easily and reversibly in a plane perpendicular to its transverse direction, with any convex shape which may be present disappearing at a bending point. The stability of the tape under shearing stress is largely maintained at a bending point.

The invention is based on the knowledge that the use of a drive band permits the guide elements for a drive of a linearly movable component to be substantially simplified, with the provided elasticity creating a high degree of design freedom for guidance and storage of the drive band. The remaining limited buckling resistance contributes to the inherent reliability of the drive since the drive band can buckle and relieve the load on the motor if the movable component were to get stuck at an unforeseen obstruction on its route.

The drive band preferably has a convex shape, as a result of which it is deformed to form a shallow channel. A drive band of this type can be deformed relatively easily in a reversible manner in a plane perpendicular to its transverse direction, in particular bent about a relatively small radius (with the convex shape disappearing at a bending point), but is difficult to deform perpendicular to this plane. A convex drive band accordingly has a particularly high inherent stability and can therefore be guided with a particularly low degree of outlay and its stability under shearing stress is particularly high; a drive which operates with this drive band is therefore distinguished by a particularly high innate functional reliability or inherent reliability since the drive band can buckle and relieve the load on the motor in the drive if the movable component were to get stuck at an unforeseen obstruction on its route.

The drive band likewise preferably has a perforation in which a pinion which can be driven by a motor engages.

The drive band in the domestic appliance is particularly preferably also bent. This means that the drive band can be used under conditions where space is limited.

According to another preferred refinement, the drive band is produced from steel and more advantageously has a coating comprising a slip agent, in particular PTFE plastic. This facilitates movement of the drive band in the domestic appliance and ensures reliable operation over a long period of time.

According to one preferred refinement, the domestic appliance is designed as an apparatus for drying laundry by means of an air stream and has a drum for holding the laundry and a duct system for conducting the air stream, with the duct system having a section which is arranged at the outflow end of the drum and in which the air stream is conducted in a downward direction and in which a filter for capturing lint from the air stream is arranged and the filter has an associated scraper for scraping off lint which have been captured, and with the scraper being the component which can be moved by the drive band.

The filter is preferably a channel which is arranged approximately horizontally and is curved in the downward direction, and the scraper is a foil which can be resiliently supported on the filter and is bent in accordance with the channel. The filter, which in an apparatus from the prior art has to cover a comparatively large surface area corresponding approximately to an entire opening in the drum, is redesigned to form a comparatively compact component in the form of a channel which can be arranged, in particular, below a charge opening for the drum in the end plate of a tumble dryer which is otherwise of customary design. The end plate firstly provides a support structure for a front face of the apparatus and a front support for the drum, and secondly supports a door for closing the drum. The shape selected for the filter provides a considerably enlarged surface compared to a flat filter and thus provides relatively little flow resistance to the air stream flowing through it. In this case, the shape of the cross section of the channel is of little importance, with a cross section which is predominantly flat and, in particular, corresponds more or less to a curve of a conical section proving expedient and appropriate. The curved shape provides the filter with stability and means said filter can be easily and reliably cleaned at regular intervals by means of a correspondingly designed scraper. Accordingly, the section of the duct system with the filter is preferably extended by an end plate, with the filter also being arranged in the end plate.

In addition, the scraper is in a rest position at a first end of the channel and a chute for holding lint which have been-scraped off is provided at a second end of the channel.

In addition, the filter is preferably supported on a grid-like filter support. As a result, spring forces which the foil exerts on the filter are absorbed and the load on the filter is reduced.

Exemplary embodiments of the invention are explained below with reference to the drawing, in which, in detail,

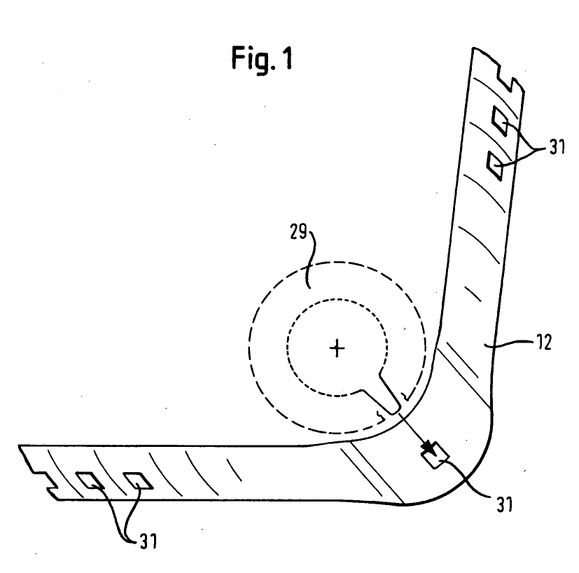

FIG. 1 shows a perforated drive band which can be driven by a pinion;

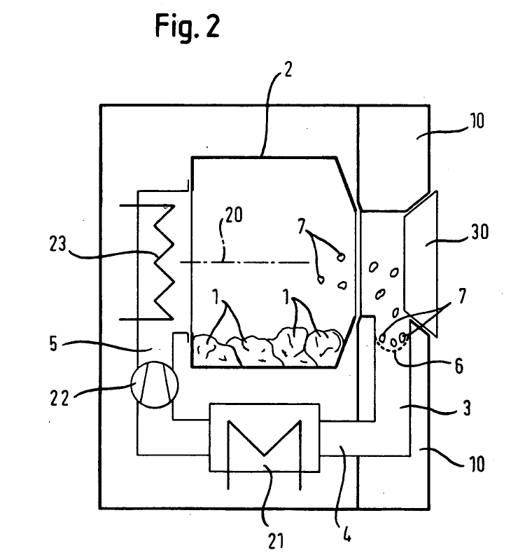

FIG. 2 shows a schematic cross section through a tumble dryer; and

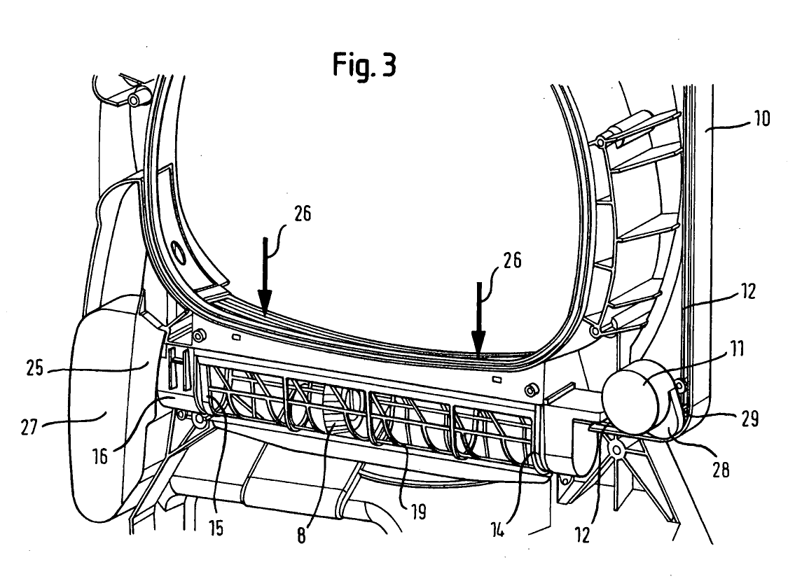

FIG. 3 shows a partial view of an end plate of a tumble dryer, provided with a filter and a scraper as well as a reservoir for holding lint which have been scraped off.

Corresponding parts of the tumble dryer are each provided with the same reference symbols in all of the figures of the drawing.

FIG. 1 shows a detailed view of a drive band 12 for driving a linearly movable component 8, 9 (not illustrated in FIG. 1, cf. subsequent figures) of a domestic appliance. The straight sections of the drive band 12 are convex, that is to say are provided with a certain curvature, with the curvature disappearing in a reversible manner when the drive band 12 is bent; the bent section of the drive band 12 therefore does not have a convex shape. The drive band 12 is provided with perforations 31 of which only some are shown and in which the pinion 29, of which only one tooth is shown, engages, as indicated by an arrow. The drive band 12 and the pinion 29 are illustrated at a distance from one another in FIG. 1 solely for the sake of clarity. The drive band 12 is bent over a section which corresponds approximately to a right angle and is guided around the pinion 29. On account of its inherent dimensional stability, said drive band can be guided largely without a special guide device outside a bending point, and this means it can be used particularly advantageously in the domestic appliance, specifically a tumble dryer, which is described below.

According to FIG. 2, the apparatus for drying laundry 1 by means of an air stream comprises a drum 2 for holding the laundry 1, it being possible for the drum 2 to rotate about an axis 20 in order to agitate the laundry 1 in the air stream. The air stream is conducted away from the drum 2 and back to it again in a duct system 3, 4, 5. The duct system 3, 4, 5 comprises a falling section 3 which partly passes through an end plate 10 for charging the drum 2, a horizontal section 4 below the drum 2 and a rising section 5 through which the air stream is passed to the drum 2 again. The falling section 3 contains a filter 6 which is arranged in the end plate 10 and from which the lint 7 which are extracted from the air stream of the laundry 1 are captured. Means (which are not illustrated in FIG. 2) can be used to scrape off lint 7 which have been captured from the filter 6 in order to ensure as low as possible a flow resistance of the filter 6. The horizontal section 4 which follows the falling section 3 contains a heat exchanger 21 in which the air stream is cooled in order to remove entrained water vapor by condensation. Condensed water is separated from the air stream using means which are known per se (not illustrated in FIG. 2), and disposed of. The rising section 5 which follows the horizontal section 4 contains a blower 22, which drives the air stream through the drum 2 and the duct system 3, 4, 5, and a heating device 23 which is used to heat up the air stream before it enters the drum 2 again. All or part of the heat exchanger 21 and the heating device 23 may optionally be part of a recuperative heat-transport system, in particular a heat pump. The end plate 10 firstly forms a support structure for a front face of the apparatus and a front support for the drum 2, and secondly supports a door 30 for closing the drum 2.

FIG. 3 shows how the filter 6, which is supported on a filter support 19, is embedded in the end plate 10 of the tumble dryer. In this case, the end plate 10 is seen from the drum 2. The air stream which may have left the drum 2 enters the end plate 10 along arrows 26 and thus reaches the filter 6 (not illustrated for the sake of clarity) on the filter support 19. At this point, the air stream is freed from entrained lint. The captured lint are removed by the scraper 8, 9 by said scraper being moved from a first end 14 of the filter to a second end 15 by means of a motor 11 and a transmission which is formed by said convex drive band 12. The motor 11 drives the pinion 29, which in FIG. 3 is largely covered by a cover 28, by means of a gear mechanism (not illustrated). The lint which are thus scraped off are passed to the chute 16 and the reservoir 25, 27. As illustrated in FIG. 1, the drive band 12 is perforated and is driven by the motor 11 by means of the pinion 29 which is partially covered by a cover 28. The drive band 12 has the advantage of inherent stability, which means a special guide means is not necessary, and is also stable when the foil 8 becomes stuck; the drive band 12 can prevent a corresponding excessive loading by bending outward. The drive band 12 is connected to the carriage 9 (see FIG. 1) in particular in such a way that a lug or screw connection (not illustrated) which is provided on the drive band 12 engages in a corresponding recess 24 in the carriage 9.

### LIST OF REFERENCE SUMBOLS

1. Laundry
2. Drum
3. Duct system, falling section
4. Duct system, horizontal section
5. Duct system, rising section
6. Filter
7. Lint
8. Scraper, foil
9. Scraper, carriage
10. End plate
11. Motor
12. Transmission
14. First end
15. Second end
16. Chute
19. Filter support
20. Axis of the drum
21. Heatexchanger
22. Blower
23. Heating device
24. Recess in the carriage
25. Reservoir, first part
26. Air stream in the door
27. Reservoir, second part
28. Cover
29. Pinion
30. Door
31. Perforation

1-11. (canceled)

12. A household appliance comprising:
a housing;
a linearly movable component mounted for linear movement with respect to the housing; and
a drive band connected to the component wherein the component can be moved by means of the drive band.

13. The household appliance according to claim 12, wherein the drive band has convex cross-section.

14. The household appliance according to claim 12, wherein the drive band has a perforation and is driven by a motor by means of a pinion.

15. The household appliance according to claim 12, wherein the drive band is bent.

16. The household appliance according to claim 12, wherein the drive band is made from steel.

17. The household appliance according to claim 12, wherein the drive band has a coating comprising a slip agent.

18. The household appliance according to claim 12, wherein the appliance includes an apparatus for drying laundry by means of an air stream, the appliance comprising a drum for holding the laundry and a duct system for conducting the air stream, the duct system including a section located downstream from the drum and in which the air stream is conducted in a downward direction and in which a filter for capturing lint from the air stream is arranged and the filter has an associated scraper for scraping off lint which have been captured, and with the scraper being the linearly movable component which can be moved by the drive band.

19. The household appliance according to claim 18, in which the filter includes a channel which is arranged approximately horizontally and is curved in the downward direction, and the scraper has a foil which can be resiliently supported on the filter and is bent in accordance with the channel.

20. The household appliance according to claim 18, in which the section is extended by an end plate and the filter is arranged in the end plate.

21. The household appliance according to claim 18, in which the scraper is in a rest position at a first end of the channel and a chute for receiving lint which has been scraped off is provided at a second end of the channel.

22. The household appliance according to claim 18, in which the filter is supported on a grid-like filter support.

23. A clothes dryer comprising:
a housing;
a drum disposed within the housing and mounted for rotation with respect to the housing;
a fan generating an air flow through the dryer and a ducting system guiding the air flow, the ducting system including a section disposed downstream from the drum and upstream from the fan;
a channel having a substantially U-shaped cross-section and extending in a direction substantially transverse to the air flow through the section; and
a linearly movable component mounted for linear movement within the channel; and
a drive device disposed near a first end of the channel and including a motor driving a sprocket wheel and a drive band including multiple holes for receiving the sprocket wheel, the drive band being connected to the scraper and moving the scraper in a linear direction in response to rotational movement of the sprocket wheel, the drive band having sufficient flexibility to bend around the sprocket wheel and having sufficient rigidity to selectively apply a pushing force and a pulling force on the linearly movable component.

24. The clothes dryer according to claim 23, further comprising a grid-like filter support disposed within the section and a filter mounted on the filter support for capturing lint, the filter and filter support at least partially forming the channel.

25. The clothes dryer according to claim 24, wherein the linearly movable component includes a scraper supported by the filter support for movement with respect to the filter to remove lint from the filter as the scraper moves through the channel with respect to the filter.
